(19) United States
(12) Patent Application Publication
(10) Pub. No.: US 2009/0046056 A1
(43) Pub. Date: Feb. 19, 2009

(54) Human motion tracking device

(75) Inventors: Steven N. Rosenberg, Fairfax, VA (US); David Page, Falls Church, VA (US)

Correspondence Address: STERNE, KESSLER, GOLDSTEIN & FOX P.L.L.C., 1100 NEW YORK AVENUE, N.W., WASHINGTON, DC, 20005, US

(73) Assignee: Raydon Corporation, Daytona Beach, FL (US)

(21) Appl. No.: 12/076,241

(22) Filed: Mar. 14, 2008

Related U.S. Application Data
(60) Provisional application No. 60/906,823, filed on Mar. 14, 2007.

(51) Int. Cl. G09G 5/00

(52) U.S. Cl. 345/156

(57) ABSTRACT

A “human motion tracking” device (HMT) that translates natural body movements into computer-usable data. The data is transmitted to a simulation application as if it came from any conventional human interface device (HID). This allows an individual to interact with the application without the need for a conventional computer input device (e.g., a keyboard, mouse, etc.). The HMT captures a user's heading as well as the individual's current stance (i.e. standing, sitting, kneeling, etc.). The HMT accomplishes this by using two sensors known as an accelerometer and magnetometer to produce digital input. The digital data will then be passed from the HMT to the application.

This patent application claims the benefit of U.S. Provisional Application No. 60/906,823, filed Mar. 14, 2007, and incorporated herein by reference in its entirety.

### BACKGROUND OF THE INVENTION

1. Field of the Invention

This invention relates to human interface systems and methods that take a person's body movements and convert them into data that is usable by a computer application.

2. Related Art

In reference to the present invention, natural body movements can be viewed as physical actions that a person performs in an effort to accomplish a specific task. It can sometimes be useful to monitor such movements. An example of this would be a virtual training application where someone is being trained to perform a specific task (e.g., in a military training context, using a gun or driving a vehicle). The designer of this type of application would want to remove the need for any unnatural actions on the part of the trainee, and require only that the trainee perform the actions normally needed to accomplish the task. Ideally the military trainee, for example, would only need to perform the actions normally required in the field, and would not have to perform actions specifically related to the input or capture of data.

Advances in computer technologies have permitted the development of highly immersive software simulations. These simulations make it possible to train full-body responses to simulation stimuli. This full body immersion requires a new approach to user interaction with the simulations since the user will not have access to conventional input devices, such as a mouse or keyboard. This leads to a need for alternative methods of interfacing with these applications in situations where conventional methods for data input are not feasible.

### BRIEF DESCRIPTION OF THE FIGURES

FIG. 1 is a block diagram illustrating the use of human motion tracking devices (HMTs) to generate data used in simulation applications, according to an embodiment of the invention.

FIG. 2 illustrates magnetometer and accelerometer components of an HMT and the data generated by these components, according to an embodiment of the invention.

FIG. 3 illustrates the placement of an HMT on the front of a user's calf, and the different detected pitches that result from standing, walking, and running, according to an embodiment of the invention.

FIG. 4 illustrates the placement of HMTs on the front of a user's calf and thigh, and the different detected pitches that result from prone, sitting, kneeling, and crouching positions, according to an embodiment of the invention.

FIG. 5 illustrates the use HMTs to determine the geomagnetic heading of a user, according to an embodiment of the invention.

FIG. 6 illustrates the use of HMTs to determine the position and motion of a user's arm, according to an embodiment of the invention.

FIG. 7 illustrates the use of HMTs to capture the movement of a user's legs while walking or running, according to an embodiment of the invention.

Further embodiments, features, and advantages of the present invention, as well as the operation of the various embodiments of the present invention, are described below with reference to the accompanying drawings.

### DETAILED DESCRIPTION OF THE INVENTION

A preferred embodiment of the present invention is now described with reference to the figures, where like reference numbers indicate identical or functionally similar elements. Also in the figures, the leftmost digit of each reference number corresponds to the figure in which the reference number is first used. While specific configurations and arrangements are discussed, it should be understood that this is done for illustrative purposes only. A person skilled in the relevant art will recognize that other configurations and arrangements can be used without departing from the spirit and scope of the invention. It will be apparent to a person skilled in the relevant art that this invention can also be employed in a variety of other systems and applications.

This invention presents a solution to the above need, and includes a human motion tracking device (HMT). This device translates natural body movements into computer-usable data. The data is transmitted to an application as if it came from any conventional human interface device (HID). This allows an individual user, e.g., a trainee, to interact with the application without the need for a conventional computer input device (e.g., a keyboard, mouse, etc.). In an embodiment of the invention, the HMT captures the user's heading as well as the individual's current stance (i.e. standing, sitting, kneeling, etc.). The HMT accomplishes this by using two sensors known as an accelerometer and magnetometer to produce digital input. The digital data will then be passed from the HMT to the application.

Use of an HMT allows a user to participate in a virtual scenario for training purposes, for example. One or more HMTs can be attached to the user's body (e.g., to the user's forearm, shin, etc.), to the user's clothing, or to equipment being carried by the user (e.g., a rifle), and translates natural body movements into computer-usable data. In an embodiment of the invention the HMT captures a user's heading as well as the individual's current stance (i.e. standing, sitting, kneeling, etc.). The HMT accomplishes this by using two sensors such as an accelerometer and magnetometer to produce digital input. The magnetometer detects orientation of the HMT relative to the earth's magnetic field. The magnetometer acts in a manner similar to how a compass performs, by using the planet's magnetic field to determine the heading of a user. The accelerometer detects motion of the HMT. The digital data from these components is then passed from the HMT to a human motion synthesis application (described below) via an application program interface (API). The data is transmitted to the human motion synthesis application as if it came from any conventional human interface device (HID). This allows an individual to interact with the application (described below) without the need for a conventional computer input device (e.g., a keyboard, mouse, etc.).

In an embodiment of the invention, the synthesis application receives the output from each HMT associated with the user (i.e., the magnetometer and accelerometer outputs). This application is also made aware of where each HMT is positioned on the user. In a hypothetical example, the synthesis application would know, for example, that HMTₓ is attached to a user's shin, HMT_{y} is attached to the user's thigh, and that HMT_{z} is attached to the user's rifle. In light of the information regarding the attachment points of the HMTs, as well as the magnetometer and accelerometer outputs of each HMT, the synthesis application determines the posture, orientation, and/or location of the user. The synthesis application would be able to determine, for example, if the user is crouching, lying prone, or running. If the user is determined to be in motion, the synthesis application determines the user's heading.

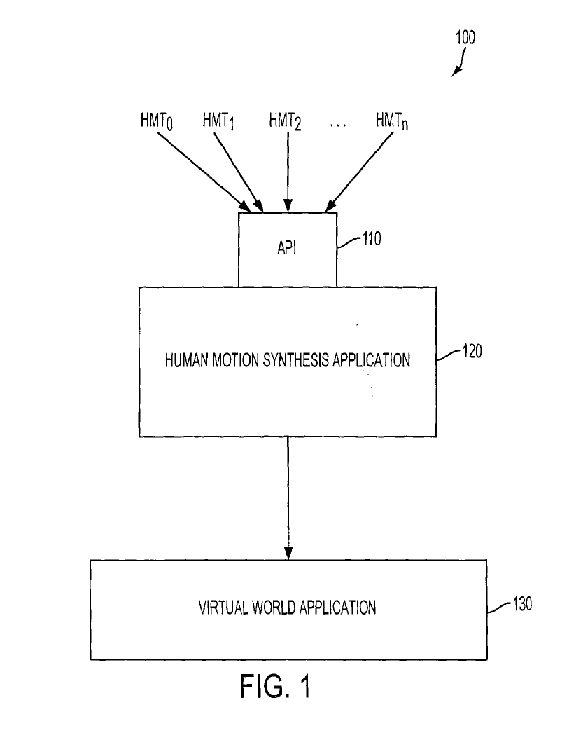

This embodiment of the invention is illustrated in FIG. 1. Here, several HMTs, shown as HMT₀ through HMTₙ, provide outputs to an API 110. The output of each HMT may include a magnetometer output and an accelerometer output. This data is then conveyed to a human motion synthesis application 120. Note that synthesis application 120 may be embodied in software, hardware, or a combination thereof. The synthesis application takes the inputs from the HMTs and synthesizes a representation of the motion, orientation, and heading of the user. As will be described in greater detail below, each HMT conveys information as to the motion and orientation of the individual HMT, and where the HMT is headed. Combined with information as to where on the user's body (or on the user's equipment) the particular HMT is located, and combined further with similar information from other HMT's on the user's body or on the user's equipment, the application 120 synthesizes a representation of how the user is oriented (e.g., crouching, kneeling, prone, etc.) and/or moving (standing, walking, or running, and in what direction).

This representation can then be fed into another application, shown in FIG. 1 as virtual world application 130. Here, the representation of the user, as produced by synthesis application 120, is integrated into a larger virtual scenario. The virtual scenario might include, for example, a virtual setting such as a forest or town, one or more virtual vehicles or other equipment, and one or more other users. In this way the user can perform in the virtual scenario and may, for example, be trained in activities necessary to perform in a real version of the scenario. The training may include interactions with other components of the virtual scenario, such as features of the setting (e.g., buildings or other structures of a virtual town), virtual equipment, and other users.

Applications 120 and 130 may be implemented in software, firmware, or any combination thereof. Software or firmware implementations of application 130 execute on one or more programmable processors, identified herein as simulation control processors. An HMT may use a wired connection or wireless connectivity to send data back to the simulation control processor(s). Connectivity to the simulation control processor(s) may be direct or may use one or more intervening data networks, such as one or more local or wide area networks.

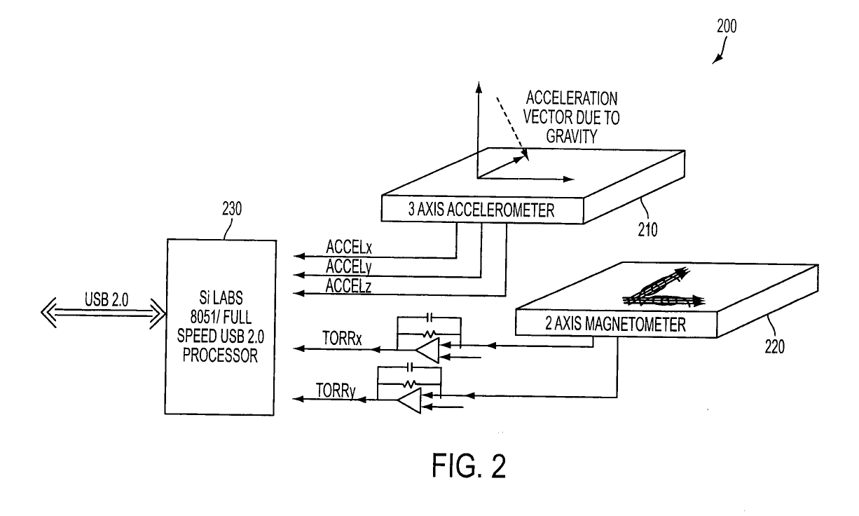

An embodiment of an HMT is shown in FIG. 2 in block diagram form. The HMT includes an accelerometer 210 and a magnetometer 220. Accelerometer 210 captures acceleration in three dimensions, and outputs the three corresponding measurements as accelₓ, accel_{y}, and accel_{z}. The accelerometer 210 determines angles of motion relative to the earth's surface using gravity as the perpendicular reference to the surface. Magnetometer 220 captures orientation on the earth's surface relative to the earth's magnetic field, and outputs the orientation as two components, torrₓ and torr_{y}. The magnetometer 220 determines rotational motion (yaw) relative to the earth's magnetic field. The signals accelₓ, accel_{y}, and accel_{z}, plus torrₓ and torr_{y} are input to synthesis application 120, as discussed above. An embodiment of the invention implements three degrees of freedom (3DOF) data extrapolations that are transmitted to the synthesis application 120 in a digital format. In the embodiment illustrated in FIG. 2, the synthesis application 120 executes on a programmable computing device, such as processor 230. One example of such a processor, not intended to limit the invention, is the 8051 microcontroller shown in FIG. 2, available Silicon Laboratories, Inc. of Austin Tex. Processor 230 may be incorporated with the HMT; alternatively, processor 230 may be located elsewhere, remote from the accelerometer 210 and the magnetometer 220. In an alternative embodiment, synthesis application 120 and virtual world application 130 may both execute on a single processor.

Regarding the physical attributes of the HMT device, in an embodiment of the invention it is small enough that it would not impede the natural body movements of a user when the user is in motion, and would not require direct input from the user during operation. User input may be necessary, however, to calibrate the HMT device. An HMT may be attached to any part of the user's body, such as the user's shin, calf, thigh, torso, shoulder, bicep, forearm, head or foot. An HMT can alternatively be integrated into an article of clothing or equipment, such as a helmet, uniform, body armor, or weapon. An HMT may be powered locally (e.g., using one or more batteries) or draw power from the simulation control processor or from a communications hub.

If multiple HMTs are attached to a user, the synthesis application 120 would need to know the physical relationships between the HMTs, e.g., the distance between an HMT on the user's calf and the HMT on his thigh, given a certain posture. Such positional relationships between HMTs may be set using physical measurements or by standardized height or weight tables. Moreover, one or more HMTs may be used in conjunction with other sensors such as perspective-sensing head mounted displays, head trackers and eye trackers to improve the user's sensation of immersion in a simulation and to provide additional input to the synthesis application 120.

In an embodiment of the invention, one or more HMTs is used within a simulation that requires simple motion input, as would be created by a user walking or running through a simulation. This implementation could utilize a single HMT device that would be used to determine a user's leg position (e.g., pitch). The HMT could be attached to the user's calf, for example. The initial position of the HMT may be entered into the synthesis application by a menu choice or by assuming that the HMT is placed in accordance with a predefined normalized stance at startup.

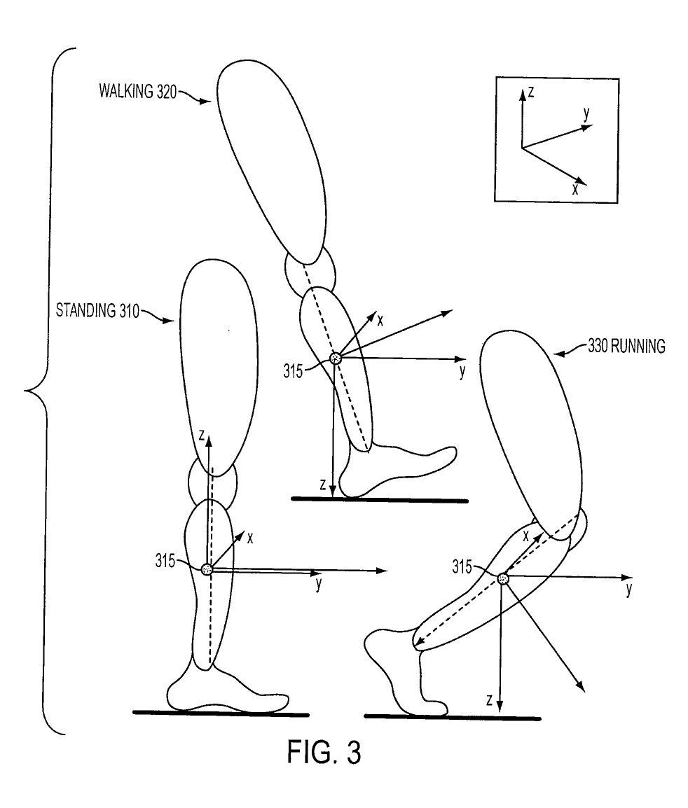

In operation, the user would place his leg in a specific position, which would then trigger events within the virtual world application. Based on the orientation and movement of the HMT, different data would be generated. The data would indicate whether the user was standing, walking, or running, for example, within the simulated environment. This is illustrated in FIG. 3. In the three examples shown, an HMT is attached to a user's calf. In each example, an HMT 315 senses orientation and motion, and relays this data to a synthesis application via an API, as discussed above. This data takes the form of signals accelₓ, accel_{y}, and accel_{z}, plus torrₓ and torr_{y}. When these signals are received and processed by the synthesis application, this application infers the position and motion of the user on the basis of these signals. In example 310, an HMT 315 has a heading parallel to the ground, essentially horizontal, which implies a standing position. In example 320, an upward pitch of the HMT 315 suggests walking. In example 330, a downward pitch suggests running.

In general, the direction of motion conveyed to the synthesis application may be derived from the direction of tilt of the user's leg, forward, back, left or right. In an embodiment of the invention, the start of motion is inferred if the pitch moves beyond a threshold, or pitch point. The direction of motion may therefore be set using an on/off tilt/pitch trip point, where the user's tilt/pitch beyond the trip point starts a uniform motion in that direction(s). The direction of motion and speed may be set as proportional to the pitch and tilt direction once they exceed a center dead-zone angle.

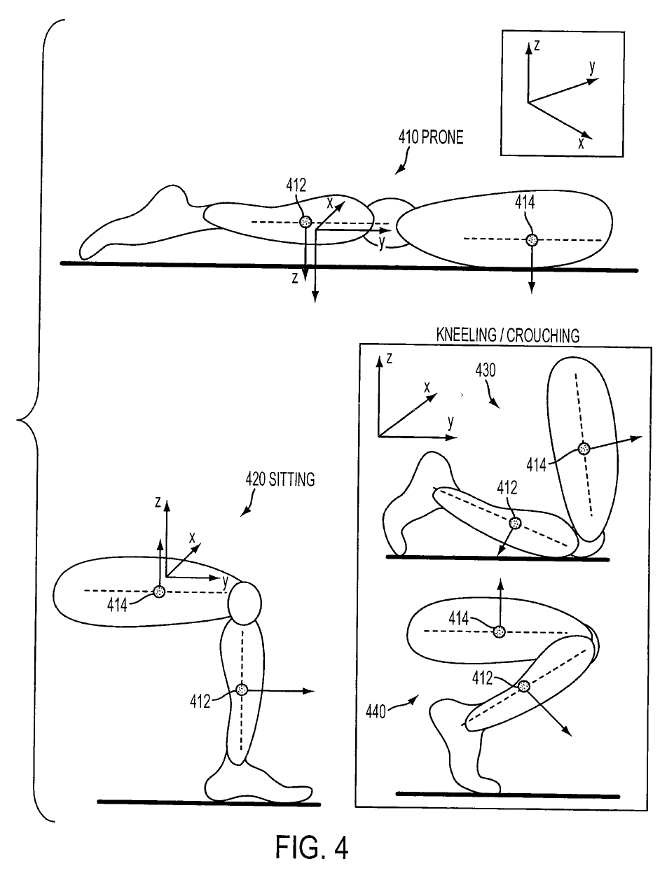

An alternative embodiment of the invention allows for more complex human stances (i.e. kneeling, sitting, prone, etc.). Here the user would be equipped with two or more HMT devices. These devices would allow the application to process the pitch of portions of the user's body, along with specific angles, to identify the more complex stances. This illustrated in FIG. 4. The HMT devices would be positioned on the thigh and on the calf, for example. This would allow the devices to detect positions and actions such as running and walking, as well as standing, kneeling, sitting, and prone positions.

In example 410, HMTs 412 and 414 attached to the user's thigh and calf indicate an essentially downward heading. Data produced by the HMTs 412 and 414 would be sent to the synthesis application, which would conclude that the user is in a prone position in this case. Detection of a crawling motion (not shown) may be achieved by detecting forward and back motion of the legs beginning from this prone position, as indicated by the position and motion of the HMTs 412 and 414 on the user's calf and thigh. In example 420, HMT 414 mounted on a user's thigh indicates an essentially upward heading while HMT 412 on the user's calf indicates an essentially horizontal heading.

This implies a sitting position, as determined by the synthesis application. In example 430, HMT 414 on the user's thigh indicates a slightly upward pitch and HMT 412 on the user's calf indicates a downward and perhaps rearward pitch. This combination implies a kneeling position. If the thigh-mounted HMT414 indicates an essentially upward heading while the calf-mounted HMT 412 indicates a downward and forward heading, a crouching position is implied, as shown in example 440. The amount or “depth” of crouch shown in example 440 would be determined by the angle of the thigh to the calf as determined, for example, by evaluating the difference in the respective detected pitches of the thigh and calf HMTs. The depth of crouch would vary to a point where the user would be determined to be kneeling and motion would stop.

As discussed above, the position of an HMT sensor may be derived by a menu choice or by an assumed normalized stance at startup, where normalized vectors would be recorded. Also, in general the direction of motion conveyed to the virtual world application may be derived from the direction of tilt of the user's leg, forward, back, left or right. Pitch may be derived from the mid-point between two pitch sensors, i.e, two HMTs. If more than two HMTs are used, pitch can be derived as a function of respective pitches sensed by some or all of the respective HMTs. In the embodiment of FIG. 4, as in that of FIG. 3, the start of motion can be inferred if the pitch moves beyond a threshold, or pitch point. Direction of motion may therefore be set using an on/off tilt/pitch trip point where user tilt/pitch beyond the trip point starts a uniform motion in that direction(s). Direction of motion and speed may be set as proportional to the pitch and tilt direction once they exceed a center dead-zone angle.

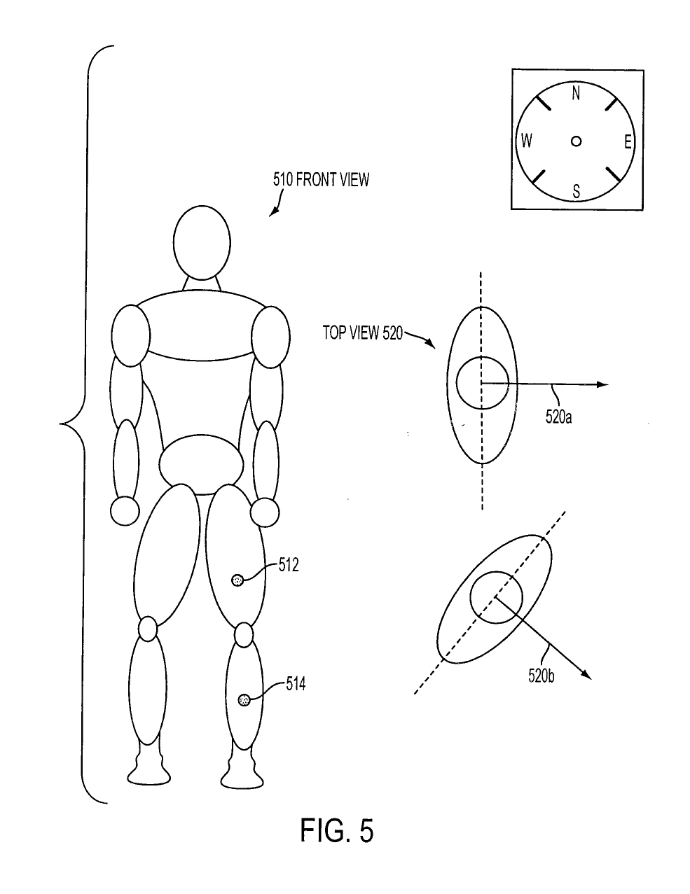

In another embodiment of the invention, one or more HMTs would allow a synthesis application to capture the user's heading, as shown in FIG. 5. This embodiment would require the use of a two or three axis magnetometer as part of an HMT. The magnetometer acts in a manner similar to how a compass performs, by using the planet's magnetic field to determine the heading of a user. As shown in front view 510, HMTs 512 and 514 can be attached to the front of a user's body, for example on the user's calf and thigh. In top view 520, the headings 520a and 520b of the user are shown. Alternatively, the HMT can be mounted elsewhere on the user's body (e.g., the chest or head), or on an article of clothing or a piece of equipment, such as a helmet.

In top view 520, the user is facing east, and the heading 520a would be detected by a magnetometer in an HMT attached to the front of the user. If the user were to turn southeast, as seen in heading 520b, this new heading would likewise be detected by the magnetometer.

As in the above embodiments, the initial orientation of the HMT may be derived by a menu choice or by an assumed normalized stance at startup. Once the user turns to face in a different direction, the magnetometer could be used to give an absolute rotation.

In some situations, the user may wish to use the invention while in a constrained physical environment. He may have to use the invention for training purposes while in a confined space, perhaps in a tent or barracks. In such a case, the invention can be configured such that a limited motion by the user can be interpreted as a motion having a proportionally greater displacement. As an example, the system may detect that the user raises his right arm 30 degrees, but may then extrapolate the detected motion, so that for simulation purposes this motion is treated as if the user raised his arm 90 degrees. In this manner, the user could use the invention and take part fully in a simulated exercise while performing only the reduced motions permitted by his physical location.

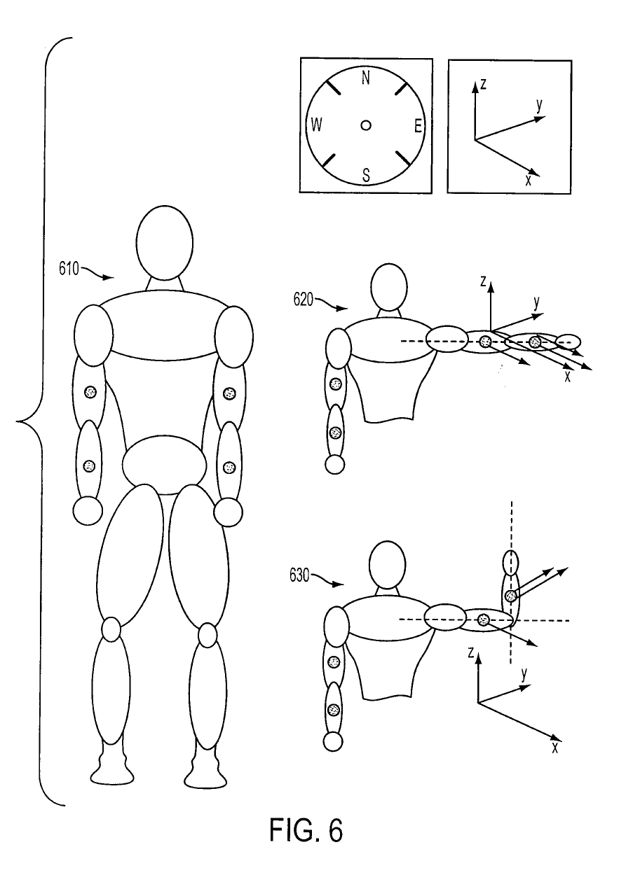

In an embodiment of the invention, tracking of arm motions is accomplished by placing HMT devices on the user's forearm and bicep, as shown in example 610 of FIG. 6. The invention would make use of a magnetometer and accelerometer to determine the angular position of the arm as well as rotation of the forearm, as shown in examples 620 and 630 of FIG. 6. This embodiment could be combined with any of the implementations previously discussed, or could be implemented by itself. Similar to the previously described embodiments, the initial positions of the HMTs may be derived by a menu choice or by an assumed normalized position at startup. The length of the forearm and upper arm may also be needed to capture the exact orientation or motion of the user's arm. The length of the forearm and biceps may be normalized, measured, or based on normalized height and weight tables for users of comparable size. These lengths and the relative angles of the forearm and biceps as detected by the HMTs can then be used to create and adjust an arm avatar displayed or recorded in the virtual world application. An additional HMT on the hand or wrist of the user could also be used to derive the rotation of the hand relative to the forearm.

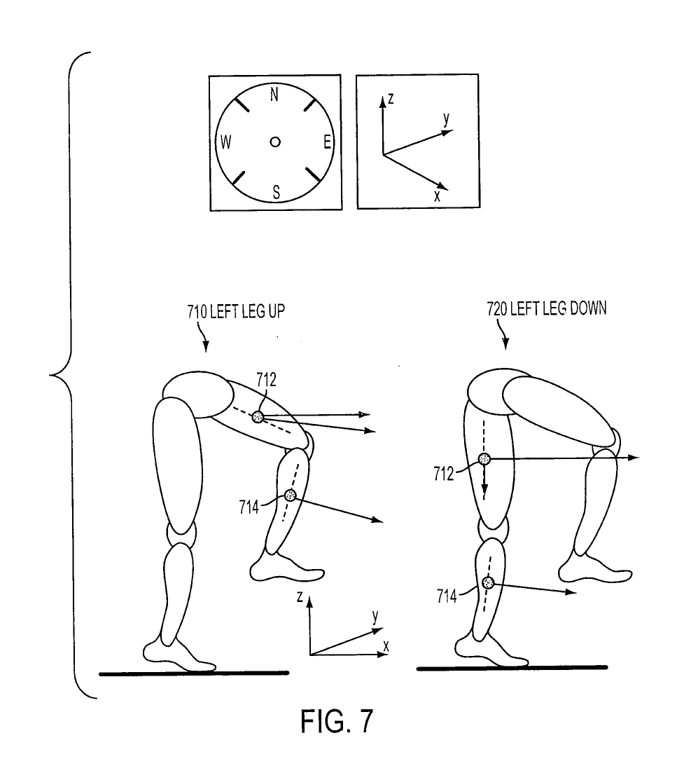

Another embodiment of the invention would dynamically track a user's leg movements when the user is walking or running, in order to create a simulation of a person doing these actions. This is illustrated in FIG. 7. In example 710, the user's left leg is raised in order to take a step; in example 720, the user's left leg is on the ground, but the right leg is raised. In this implementation a user may be required to run or walk in place to simulate running or walking. This would be accomplished by placing an HMT 712 on the user's thigh and an HMT 714 on the calf, for example, as shown. Here these devices would transmit angular data that would reflect the position of each leg while walking or running, and could also transmit a magnetometer reading to indicate heading. The application in turn would translate this data into events that would simulate a user running or walking depending on how fast the legs were moving in place. The distinction between walking and running could be determined by the computed angular displacement (pitch) of the calf sensor, as shown in examples 320 and 330 of FIG. 3.

As stated above, the invention can be configured such that a limited motion by the user can be interpreted as a motion having a proportionally greater displacement. In an analogous manner, the user might walk or run in a limited manner, e.g., a shuffle; the system would then detect such a motion and extrapolate this into a full walking or running motion. The pace of walking or running could be derived on a proportional basis from the rate of shuffle.

It is to be appreciated that the Detailed Description section, and not the Abstract section, is intended to be used to interpret the claims. The Abstract section may set forth one or more but not all exemplary embodiments of the present invention as contemplated by the inventors, and thus, are not intended to limit the present invention and the appended claims in any way.

The present invention has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

While some embodiments of the present invention have been described above, it should be understood that it has been presented by way of examples only and not meant to limit the invention. It will be understood by those skilled in the art that various changes in form and detail may be made therein without departing from the spirit and scope of the invention as defined in the appended claims. Thus, the breadth and scope of the present invention should not be limited by the above-described exemplary embodiments, but should be defined only in accordance with the following claims and their equivalents.

What is claimed is:

1. A system for tracking human movement and position, comprising:
(a) a first human motion tracking device configured to detect a heading, a pitch, and a motion, and to generate a plurality of signals corresponding to said heading, pitch and motion;
(b) a human motion synthesis application, configured to receive said plurality of signals and to synthesize posture, movement, and orientation information for a user; and
(c) a virtual world application, configured to receive said synthesized information and integrate said user into a simulated virtual environment.

2. The system of claim 1, wherein said human motion tracking device is attachable to the user.

3. The system of claim 1, wherein said human motion tracking device is attachable to equipment carried by the user.

4. The system of claim 1, wherein said simulated virtual environment comprises a training environment for said user.

5. The system of claim 1, wherein said human motion tracking device comprises:
(a) a magnetometer configured to determine a heading and a rotational motion relative to the earth's magnetic field; and
(b) an accelerometer configured to determine motion and pitch relative to the earth's surface.

6. The system of claim 5, wherein said human motion tracking device is co-located with a processor configured to execute said synthesis application.

7. The system of claim 5, wherein said accelerometer is configured to detect acceleration in three dimensions.

8. The system of claim 1, further comprising:
a second human motion tracking device configured to detect a second heading, a second pitch, and a second motion, and to generate a second plurality of signals corresponding to said second heading, second pitch, and second motion,
wherein said human motion synthesis application is further configured to receive said second plurality of signals to synthesize the posture, movement, and orientation information for said user.

9. The system of claim 8, wherein a spatial relationship between said first and second human motion tracking devices is determined by a physical measurement that is input to said synthesis application.

10. The system of claim 8, wherein a spatial relationship between said first human motion tracking device and said second human motion tracking device is determined by a standardized table, wherein said determination is input to said synthesis application.

11. The system of claim 1, wherein said synthesis application is configured to receive said plurality of signals through an application programming interface.

12. The system of claim 1, wherein a processor configured to execute said virtual world application is configured to receive said synthesized information thorough a wireless connection.

13. The system of claim 1, wherein a processor configured to execute said virtual world application is configured to receive said synthesized information through a wired connection.

14. The system of claim 1, where said human motion tracking device is powered by one or more batteries.

15. The system of claim 1, wherein said human motion tracking device is powered by a power source external to said human motion tracking device.
